(19) United States
(12) Patent Application Publication
(10) Pub. No.: US 2016/0117140 A1
(43) Pub. Date: Apr. 28, 2016

(54) ELECTRONIC APPARATUS, PROCESSING METHOD, AND STORAGE MEDIUM

(71) Applicant: Kabushiki Kaisha Toshiba, Tokyo (JP)

(72) Inventors: Shogo Ikeda, Tachikawa Tokyo (JP); Tatsuo Yamaguchi, Kunitachi Tokyo (JP); Yuki Kanbe, Ome Tokyo (JP); Toshiyuki Yamagami, Fussa Tokyo (JP)

(21) Appl. No.: 14/674,193

(22) Filed: Mar. 31, 2015

(30) Foreign Application Priority Data
Oct. 23, 2014 (JP) 2014-216159

(51) Int. Cl. G06F 3/14; G06F 3/0488

(52) U.S. Cl. CPC G06F 3/1454; G06F 3/04883

(57) ABSTRACT

According to one embodiment, an electronic apparatus includes circuitry. The circuitry is configured to display on a display, a first region of an electronic document comprising a first stroke input by handwriting on the electronic apparatus and a second stroke input by handwriting on another apparatus. The first region is being displayed on the display and is at least a part of the electronic document. A second region is visually distinguishable from other region of the electronic document when a first operation is performed. The second region is being displayed in the another apparatus and is at least a part of the electronic document.

### CROSS-REFERENCE TO RELATED APPLICATIONS

This application is based upon and claims the benefit of priority from Japanese Patent Application No. 2014-216159, filed Oct. 23, 2014, the entire contents of which are incorporated herein by reference.

### FIELD

Embodiments described herein relate generally to an electronic apparatus, a processing method, and a storage medium.

### BACKGROUND

Recently, various electronic apparatuses such as tablets, PDAs, and smartphones, have become widespread. Most of these electronic apparatuses comprise a touchscreen display to facilitate input operations by the user.

Also, recently, a system for sharing information among several users by using the technology of an electronic information board, an intelligent whiteboard, etc., has been developed.

However, up to the present, technology for allowing a user to easily view the same part as that focused on by another user has not been taken into account.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an appearance of an electronic apparatus according to an embodiment.

FIG. 2 is an exemplary illustration showing connection between electronic apparatuses which use handwriting sharing service.

FIG. 3 is an exemplary illustration for describing an outline of data flow between the electronic apparatus of FIG. 1 (a handwriting collaboration server system) and each of other electronic apparatuses.

FIG. 4 is an exemplary illustration showing a screen (a canvas) which shares information among a plurality of electronic apparatuses.

FIG. 5 is an exemplary illustration showing a handwritten document handwritten on a touchscreen display of the electronic apparatus of FIG. 1.

FIG. 6 is an exemplary illustration for describing processing executed by the handwriting sharing service.

FIG. 7 is an exemplary illustration showing a canvas for sharing information among a plurality of electronic apparatuses.

FIG. 8 is an exemplary illustration showing the state in which different display areas are seen by an organizer and a participant.

FIG. 9 is an exemplary illustration for describing a menu displayed on the screen.

FIG. 10 is an exemplary illustration for describing preview processing executed by the electronic apparatus of FIG. 1.

FIG. 11 is an exemplary illustration showing a preview screen which displays the entire canvas.

FIG. 12 is an exemplary illustration showing the state in which a display area is changed to a different display area by the preview processing.

FIG. 13 is an exemplary block diagram showing a configuration of the electronic apparatus of FIG. 1.

FIG. 14 is an exemplary block diagram showing a configuration of a handwriting sharing application program executed by the electronic apparatus of FIG. 1.

FIG. 15 is an exemplary flowchart showing a procedure of the preview processing executed by the electronic apparatus of FIG. 1.

### DETAILED DESCRIPTION

Various embodiments will be described hereinafter with reference to the accompanying drawings. In general, according to one embodiment, an electronic apparatus comprises circuitry. The circuitry is configured to display on a display, a first region of an electronic document comprising a first stroke input by handwriting on the electronic apparatus and a second stroke input by handwriting on another apparatus. The first region is being displayed on the display and is at least a part of the electronic document. A second region is visually distinguishable from other region of the electronic document when a first operation is performed. The second region is being displayed in the another apparatus and is at least a part of the electronic document.

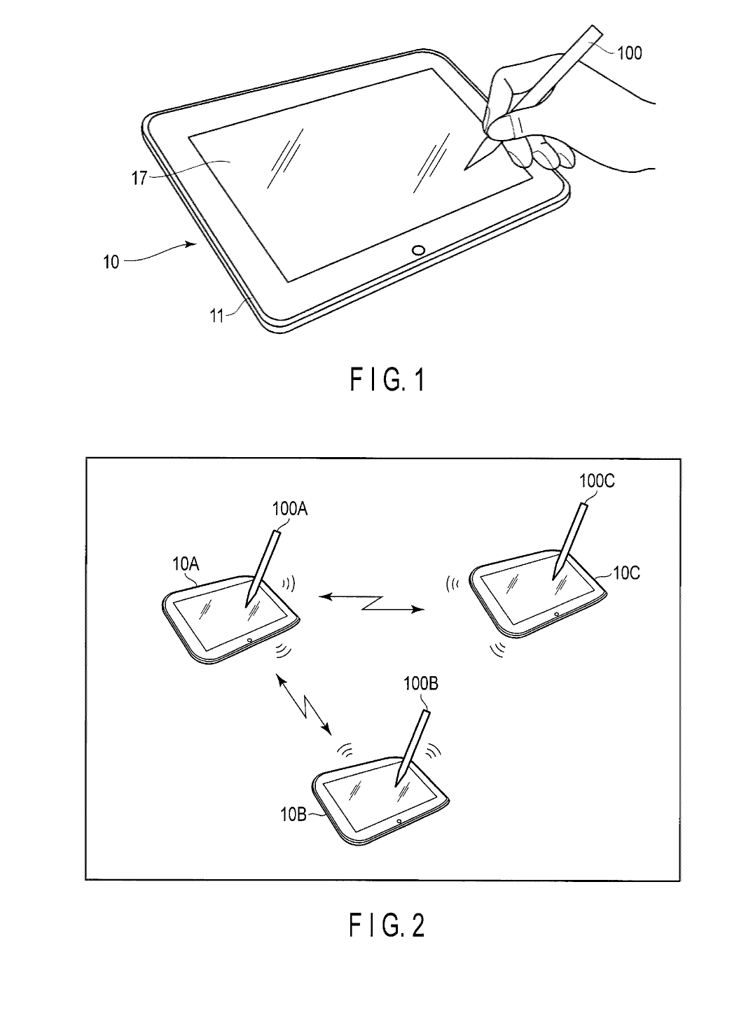

FIG. 1 is an exemplary perspective view showing an appearance of an electronic apparatus according to the embodiment. The electronic apparatus is a pen-based portable electronic apparatus capable of making handwriting inputs with a pen (stylus) or a finger, for example. The electronic apparatus can be realized as a tablet computer, a notebook personal computer, a smartphone, a PDA, etc. In the following descriptions, a case where the electronic apparatus is realized as a tablet computer 10 is assumed. The tablet computer 10 is a portable electronic apparatus which is also referred to as a tablet or a slate computer. The tablet computer 10 comprises a main body 11 and a touchscreen display 17, as shown in FIG. 1. The touchscreen display 17 is arranged to be laid over a top surface of the main body 11.

The main body 11 comprises a thin box-shaped housing. In the touchscreen display 17, a flat-panel display and a sensor are incorporated. The sensor detects a position (a contact position) on a screen of the flat-panel display where the stylus or the finger is brought into contact. The flat-panel display may be, for example, a liquid crystal display (LCD). As the sensor, a capacitive touchpanel or an electromagnetic induction digitizer, for example, can be used. In the following, a case where both of the two types of sensors, i.e., a digitizer and a touchpanel, are incorporated into the touchscreen display 17 is assumed.

The touchscreen display 17 can detect a position on the screen where the finger is brought into contact, and also a position on the screen where the stylus is brought into contact. The stylus 100 may be, for example, an electromagnetic induction stylus (a digitizer stylus). A user can write a character, etc., on the screen of the touchscreen display 17 by using the stylus 100. During the handwriting input operation, a locus of movement of the stylus 100 on the screen, that is, a stroke input by hand, is drawn in real time on the screen. A locus of movement of the stylus 100 while the stylus 100 is in contact with the screen corresponds to one stroke. A set of many strokes corresponding to characters or figures, etc., which are input by hand constitutes a handwritten document.

One stroke is represented by a set of a plurality of point data corresponding to points on the stroke, respectively. Each point data represents the coordinates (an X-coordinate and a Y-coordinate) of the corresponding point.

Further, the tablet computer 10 comprises a handwriting collaboration function. The handwriting collaboration function executes handwriting sharing service which allows various electronic documents to be shared among electronic apparatuses. The various electronic documents may be, for example, a handwritten document, text data, presentation data, word processing data, image data, spreadsheet data, and any combination thereof. The handwriting sharing service allows users of electronic apparatuses to view shared information, exchange information among the electronic apparatuses, and edit an electronic document including handwritten information by collaboration work with other users of the electronic apparatuses.

The handwriting sharing service distributes in real time information (including handwritten data) which is input to an electronic apparatus participating in this service(i.e., a logged-in electronic apparatus) to each of other electronic apparatuses participating in this service (i.e., other logged-in electronic apparatuses). In this way, the contents of an electronic document displayed on display screens of their respective electronic apparatuses can be synchronized. Information input by a different user, i.e., text, strokes input by hand, etc., may be displayed in a different form (for example, in a different color). Also, a stroke being input or the most recently input stroke may be displayed in a form different from that of the other strokes, or a stroke input within a predetermined period (for example, from 10 seconds ago) may be displayed in a form different from that of the other strokes such that the stroke is distinguishable from the other strokes.

The handwriting sharing service is used by a group of several people. The group of several people who use the handwriting sharing service may include one group owner (an organizer) and one or more participants.

FIG. 2 shows an example of connection between electronic apparatuses which use the handwriting sharing service.

An electronic apparatus 10A is a tablet computer used by user A. An electronic apparatus 10B is a tablet computer used by user B. An electronic apparatus 100 is a tablet computer used by user C. Each of these electronic apparatuses 10A, 10B, and 10C comprises a handwriting collaboration function equivalent to that of the tablet computer 10 of the present embodiment.

The electronic apparatuses 10A, 10B, and 10C are connected to each other via a wired network or a wireless network. In the following, a case where the electronic apparatuses 10A, 10B, and 10C are connected to each other via a wireless network is assumed. As a method for wirelessly connecting the electronic apparatuses 10A, 10B, and 10C with each other, an arbitrary wireless connection standard which allows a plurality of apparatuses to be wirelessly connected with each other can be used. For example, Bluetooth (registered trademark) or Wi-Fi Direct (registered trademark), etc., may be used.

Any one of the electronic apparatuses 10A, 10B, and 10C can function as a server (a handwriting collaboration server system) configured to manage the handwriting sharing service. An electronic apparatus of the group owner may act as the server (the handwriting collaboration server system). The group owner corresponds to an organizer of the handwriting sharing service.

The server (the handwriting collaboration server system) may determine whether or not to permit each electronic apparatus requesting participation in the handwriting sharing service to participate in the handwriting sharing service (group), that is, to log into the handwriting collaboration server system (handwriting sharing service). Only the apparatus which has received permission of participation (log-in) from the handwriting collaboration server system may be allowed to log into the handwriting sharing service, that is, to participate in this group.

Here, as a method for each apparatus to log into a handwriting collaboration server system (handwriting sharing service), a method of using an ID (an account) of this apparatus itself to log into the handwriting sharing service may be used. Alternatively, a method of using an ID (an account) of the user who uses this apparatus to log into the handwriting sharing service may be used. That is, log-in to the handwriting sharing service and log-out from the same may be either those which use the ID (account) of the electronic apparatus itself or those which use the ID (account) of the user.

Now, a case where the electronic apparatuses 10A, 10B, and 10C have logged into the handwriting sharing service, that is, the electronic apparatuses 10A, 10B, and 10C are participating in the same handwriting sharing service is assumed. In each of the electronic apparatuses 10A, 10B, and 10C, a share screen (a canvas) on which shared information can be viewed is displayed. This screen (canvas) is used as a display area (an edit region) common among the electronic apparatuses 10A, 10B, and 10C. The screen (canvas) enables visual communication among the electronic apparatuses 10A, 10B, and 10C. The visual communication enables information such as text, images, handwritten characters, hand-drawn figures, diagrams, etc., to be shared and exchanged among the apparatuses in real time.

Data (text, handwritten data, etc.) input by users A, B, and C on the canvases of their own electronic apparatuses, respectively, are not only displayed on their own share screens (canvases), but also reflected in the share screen of the electronic apparatus of each of the other users in real time. Consequently, information (text, handwritten data, etc.) which has been input by typing or by handwriting by each of users A, B, and C can be exchanged/shared among users A, B, and C.

Further, the electronic apparatuses 10A, 10B, and 10C can display the same content such as a conference material on their canvases. In this case, handwritten data input by hand to each of the electronic apparatuses is displayed over this content. Users A, B, and C can exchange/share among users A, B, and C handwritten characters, a hand-drawn figure, etc., provided over the content while viewing the same content.

Note that the visual communication does not always have to be two-way communication, but may be one-way communication that information is transmitted from the electronic apparatus 10A to the electronic apparatuses 10B and 10C. In this case, the canvas displayed in each of the electronic apparatuses serves as a display area capable of displaying information input to other electronic apparatuses. The size of the canvas can be set arbitrarily, and can be set to exceed a physical screen size (a resolution) of each electronic apparatus.

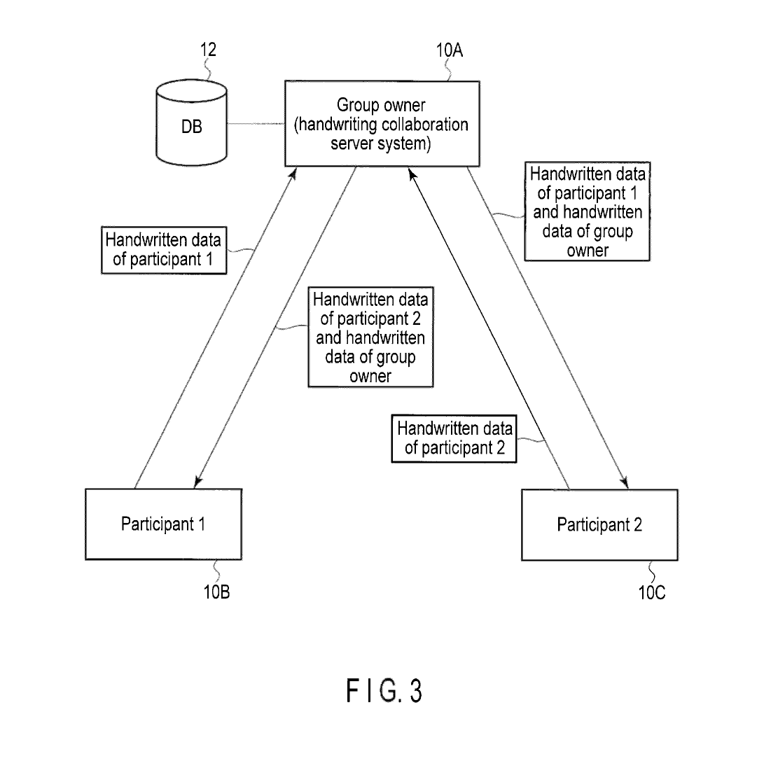

FIG. 3 shows a flow of data between the handwriting collaboration server system and each of the electronic apparatuses.

In FIG. 3, a case where the electronic apparatus 10A operates as the handwriting collaboration server system is assumed. That is, user A of the electronic apparatus 10A is the group owner, user B of the electronic apparatus 10B is a participant (participant 1), and user C of the electronic apparatus 10C is another participant (participant 2).

In the following, a case where handwritten data is exchanged/shared among the electronic apparatuses is exemplified, although the present embodiment is not limited to this case. Referring to the exemplary case, a flow of data between the handwriting collaboration server system and each of the electronic apparatuses will be described.

The handwriting collaboration server system (electronic apparatus 10A) receives handwritten data input by hand to the electronic apparatus 10B from the electronic apparatus 10B. Also, the handwriting collaboration server system (electronic apparatus 10A) receives handwritten data input by hand to the electronic apparatus 10C from the electronic apparatus 10C.

Further, the handwriting collaboration server system (electronic apparatus 10A) transmits handwritten data input by hand to the electronic apparatus 10A and the handwritten data received from the electronic apparatus 10C to the electronic apparatus 10B. Furthermore, the handwriting collaboration server system (electronic apparatus 10A) transmits handwritten data input by hand to the electronic apparatus 10A and the handwritten data received from the electronic apparatus 10B to the electronic apparatus 10C.

Accordingly, in the display of the electronic apparatus 10A, not only the handwritten data of the group owner, but also the handwritten data of participant 1, and moreover, the handwritten data of participant 2, are displayed.

Similarly, in the display of the electronic apparatus 10B, not only the handwritten data of participant 1, but also the handwritten data of the group owner, and moreover, the handwritten data of participant 2, are displayed.

Likewise, in the display of the electronic apparatus 10C, not only the handwritten data of participant 2, but also the handwritten data of the group owner, and moreover, the handwritten data of participant 1, are displayed.

The electronic apparatus 10A stores handwritten data input by hand to each of the electronic apparatuses in a database 12. The database 12 is used to manage handwritten information prepared and edited by collaboration work.

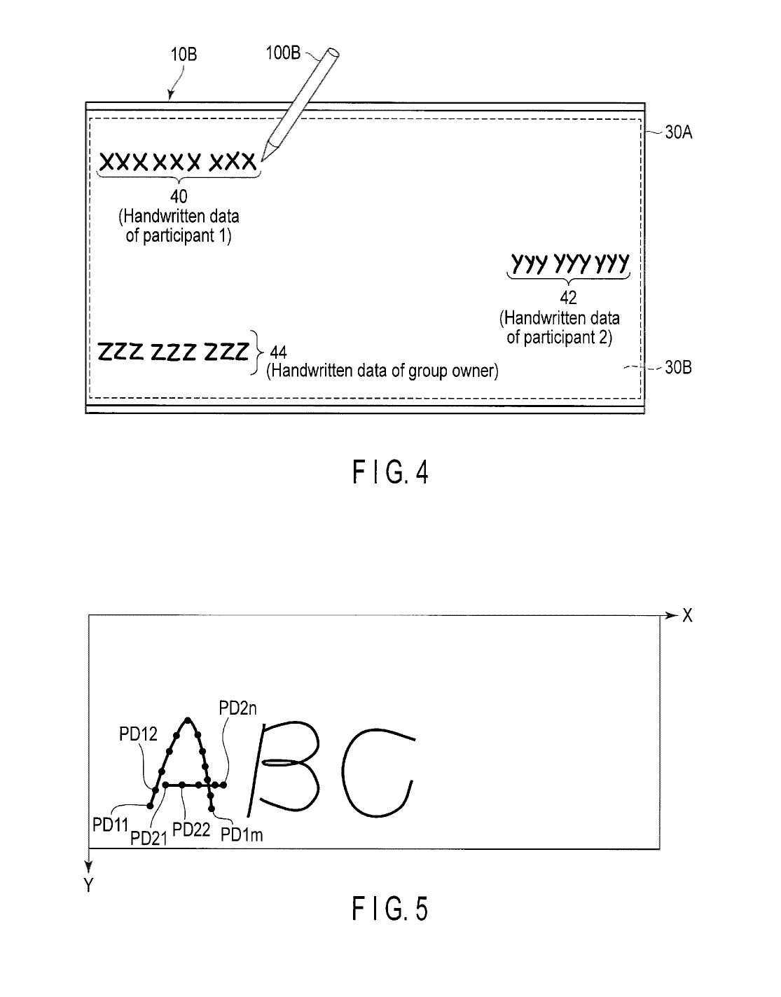

FIG. 4 shows an example of the share screen (canvas). In a canvas 30A of each of the electronic apparatuses, a transparent layer (a handwriting layer) 30B which allows handwritten data to be input is provided. On the handwriting layer 30B, handwritten data of each user is displayed.

With respect to the electronic apparatus 10B, on the canvas 30A of electronic apparatus 10B, handwritten data 40 which has been input by hand on the canvas 30A by participant 1 with a stylus 100B is displayed. Further, on the canvas 30A, handwritten data input by hand to each of the other electronic apparatuses is displayed. The handwritten data input by hand to each of the other electronic apparatuses includes handwritten data 42 input by hand to the electronic apparatus 100 of participant 2, and handwritten data 44 input by hand to the electronic apparatus 10A of the group owner.

Note that the information which is exchanged/shared between the handwriting collaboration server system and each of the electronic apparatuses is not limited to handwritten data, but may be presentation data or word processor data.

Next, with reference to FIG. 5, a stroke and point data will be described.

In FIG. 5, a case where a handwritten character string “ABC” is written in the order of “A”, “B”, and “C” is assumed.

The handwritten character “A” is represented by two strokes (a locus in the form of “̂” and a locus in the form of “−”) which are handwritten by using the stylus 100 or the like.

A locus of the stylus 100 in the form of “̂” is sampled in real time while the stylus 100 is moving. Point data (coordinate data) PD11, PD12, . . . , PD1m corresponding to a plurality of points on the locus of the stylus 100 in the form of “̂”, respectively, are thereby sequentially obtained. For example, point data representing a new position may be obtained every time the position of the stylus 100 on the screen moves by a predetermined amount. In FIG. 5, although density of point data is depicted roughly for the sake of simplicity of the illustration, a plurality of point data are obtained in higher density in reality. These point data PD11, PD12, . . . , PD1m are used for depicting the locus of the stylus 100 in the form of “̂” on the screen. The locus of the stylus 100 in the form of “̂” is depicted on the screen in real time to follow the movement of the stylus 100.

Similarly, the locus of the stylus 100 in the form of “−” is sampled in real time while the stylus 100 is moving. Point data (coordinate data) PD21, PD22, . . . , PD2n corresponding to a plurality of points on the locus of the stylus 100 in the form of “−”, respectively, are thereby sequentially obtained.

The handwritten character “B” is represented by two strokes which are handwritten by using the stylus 100 or the like. The handwritten character “C” is represented by a single stroke which is made by using the stylus 100 or the like.

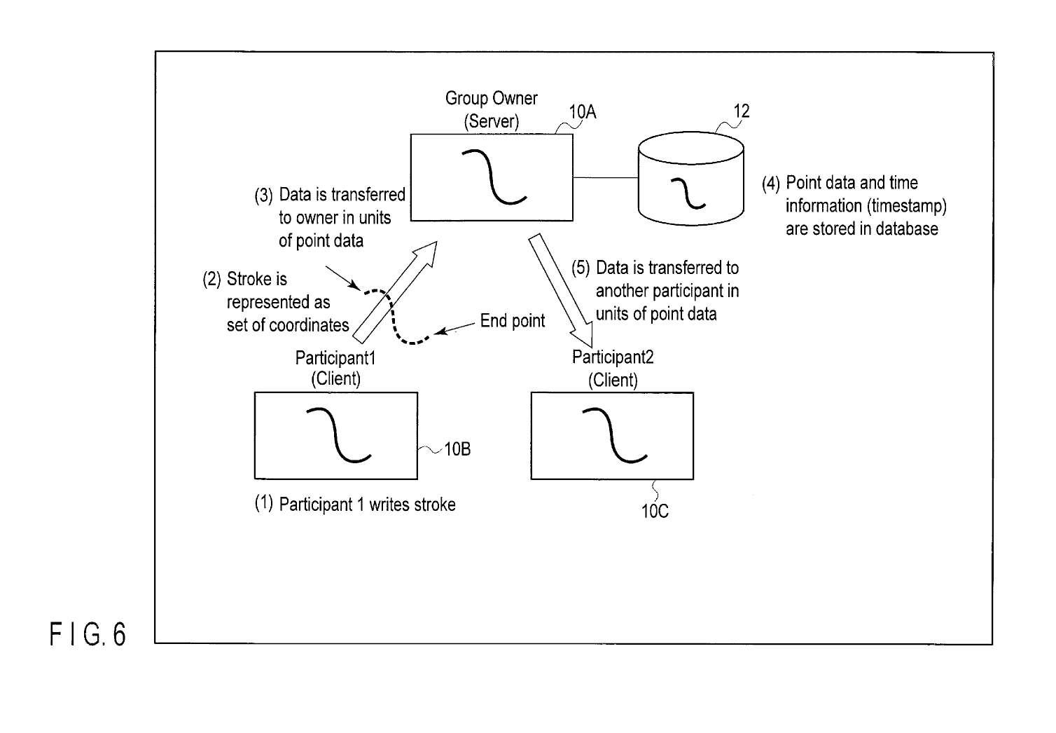

Next, with reference to FIG. 6, a flow of data for the handwritten information sharing service will be described.

In FIG. 6, a case where a discussion is held by a group of three people who are the group owner (electronic apparatus 10A), participant 1 (electronic apparatus 10B), and participant 2 (electronic apparatus 10C) is assumed. The group owner, participant 1, participant 2 may gather in a conference room with their own electronic apparatuses 10A, 10B, and 10C. Further, the group owner, participant 1, and participant 2 can conduct a discussion while looking at their own canvases of the electronic apparatuses or writing text or handwritten data on their canvases.

Data (text, handwritten characters, hand-drawn figures, etc.) input on the canvas of the electronic apparatus 10B by participant 1 is transmitted to the electronic apparatus 10A. Further, the data input by participant 1 is forwarded to the electronic apparatus 10C by the electronic apparatus 10A. Thus, the data input by participant 1 is displayed on each of the canvases of the electronic apparatuses 10A, 10B, and 10C.

Similarly, data (text, handwritten characters, hand-drawn figures, etc.) input on the canvas of the electronic apparatus 10C by participant 2 is transmitted to the electronic apparatus 10A, and is further forwarded to the electronic apparatus 10B by the electronic apparatus 10A. Thus, the data input by participant 2 is displayed on each of the canvases of the electronic apparatuses 10A, 10B, and 10C.

Further, data (text, handwritten characters, hand-drawn figures, etc.) input on the canvas of the electronic apparatus 10A by the group owner is transmitted to the electronic apparatuses 10B and 10C. Thus, the data input by the group owner is also displayed on each of the canvases of the electronic apparatuses 10A, 10B, and 10C.

In this way, the group of three people can conduct a discussion (meeting) while looking at the contents of their canvases on which data written by them is reflected.

In the following, processing of transmitting handwritten data input on the canvas of a certain electronic apparatus to another electronic apparatus will be described.

As a method of transmitting handwritten data input by hand to a certain electronic apparatus to another electronic apparatus, a method of transmitting the entire data (stroke data) of a stroke at a time every time the stroke is input by hand can be used.

Alternatively, the handwritten data may be transmitted in units of point data, instead of units of strokes. In this case, a plurality of point data corresponding to a stroke input by hand to the electronic apparatus 10B are sequentially transmitted from the electronic apparatus 10B to the handwriting collaboration server system (electronic apparatus 10A) in chronological order while this stroke is being input by hand. That is, in the order of input of the point data corresponding to the stroke, these point data are transferred from the electronic apparatus 10B to the handwriting collaboration server system (electronic apparatus 10A) one by one.

When the former method of transmitting the handwritten data in units of stroke data is used, the number of times that communication needs to be performed can be reduced.

However, stroke data is not transmitted until the handwriting input of a stroke is completed, that is, until when a contact between the stylus and the screen is released as the stylus is lifted up from the screen. Accordingly, for example, when three strokes are input by hand in order to a certain electronic apparatus, first of all, after handwriting input of the first stroke is completed, a shape of the entire first stroke is displayed at once on the canvas of another electronic apparatus. Next, after handwriting input of the second stroke is completed, a shape of the entire second stroke is displayed at once on the canvas of the aforementioned another electronic apparatus. Then, after handwriting input of the third stroke is completed, a shape of the entire third stroke is displayed at once on the canvas of the aforementioned another electronic apparatus.

As can be seen, on the canvas of another electronic apparatus, the way in which each stroke is written (the way in which a line extends) is not reproduced, but only the shape of each stroke of which the handwriting input is completed is displayed at a time.

Meanwhile, in the electronic apparatus in which handwriting input of the strokes is actually carried out, the way in which those strokes are written (the way in which lines extend) is displayed in real time.

When the latter method of transmitting the handwritten data in units of point data is used, although the number of times of communication is increased, even in a case where a stroke is input by hand to any of the electronic apparatuses, it becomes possible to reproduce the way in which that stroke is written on the canvases of all the other electronic apparatuses.

In the following, assuming the case where handwritten data is transmitted in units of point data, a specific flow of the handwritten data will be described.

(1) In the electronic apparatus 10B of participant 1, a stroke is input by hand. This stroke is displayed on the canvas of the electronic apparatus 10B in real time. That is, the stroke (line) is drawn to follow the movement of the stylus on the canvas of the electronic apparatus 10B.

(2) The stroke is represented as a set of point data (a plurality of coordinates) from its starting point to an end point.

(3) Data on this stroke (stroke data) is transmitted to the group owner (electronic apparatus 10A) in units of point data. That is, in the electronic apparatus 10B, while the stroke is being input by hand, many point data corresponding to this stroke are sequentially transmitted to the group owner (electronic apparatus 10A) in chronological order. Each point data may be transmitted to the group owner (electronic apparatus 10A) together with a stroke ID, a user ID (or a device ID), point types (starting point/middle point/end point), pen attributes (pen type, color, etc.), and the like. The stroke ID is information by which the stroke input by hand can be identified. Each electronic apparatus may generate a unique ID of several digits by using random numbers or the like, and use a value of this unique ID as the stroke ID for identifying the stroke input by hand first. For a stroke which is handwritten thereafter, a value obtained by incrementing the unique ID may be used as a corresponding stroke ID. The same stroke ID is assigned to each point data corresponding to the same stroke.

(4) The group owner (electronic apparatus 10A) receives a plurality of point data sequentially transmitted from the electronic apparatus 10B in chronological order. Further, the group owner (electronic apparatus 10A) stores the plurality of point data, together with timestamps representing the reception time (reception timing) of the plurality of point data, respectively, in the database 12. Each timestamp may represent the time when the corresponding point data is received by the group owner (electronic apparatus 10A), or represent a relative time from a point of time when the point data at the head in the same stroke is received to a point of time when the subsequent point data is received. Alternatively, each timestamp may indicate the input time when the corresponding point data was input. In this case, the electronic apparatus 10B may transmit each point data together with time information indicating the input time when that point data was input to the group owner (electronic apparatus 10A).

(5) The group owner (electronic apparatus 10A) transmits the plurality of point data which have been received from the electronic apparatus 10B to the electronic apparatus 10C.

In this case, the plurality of point data may be sequentially transmitted to the electronic apparatus 10C in chronological order at timings based on the timestamps corresponding to the point data. In this way, the plurality of point data may be transmitted to the electronic apparatus 10C at the same intervals as those at which the plurality of point data were received.

To each point data to be transmitted, the stroke ID, the user ID (or the device ID), the point types (starting point/middle point/end point), the pen attributes (pen type, color, etc.), and the like, are added.

Alternatively, when the group owner (electronic apparatus 10A) receives one of point data from the electronic apparatus 10B, the group owner (electronic apparatus 10A) may instantly transmit that point data to the electronic apparatus 10C.

Further, the group owner (electronic apparatus 10A) can draw a locus, which corresponds to a stroke input by hand to the electronic apparatus 10B, on the canvas of the group owner in real time, based on the point data from the electronic apparatus 10B.

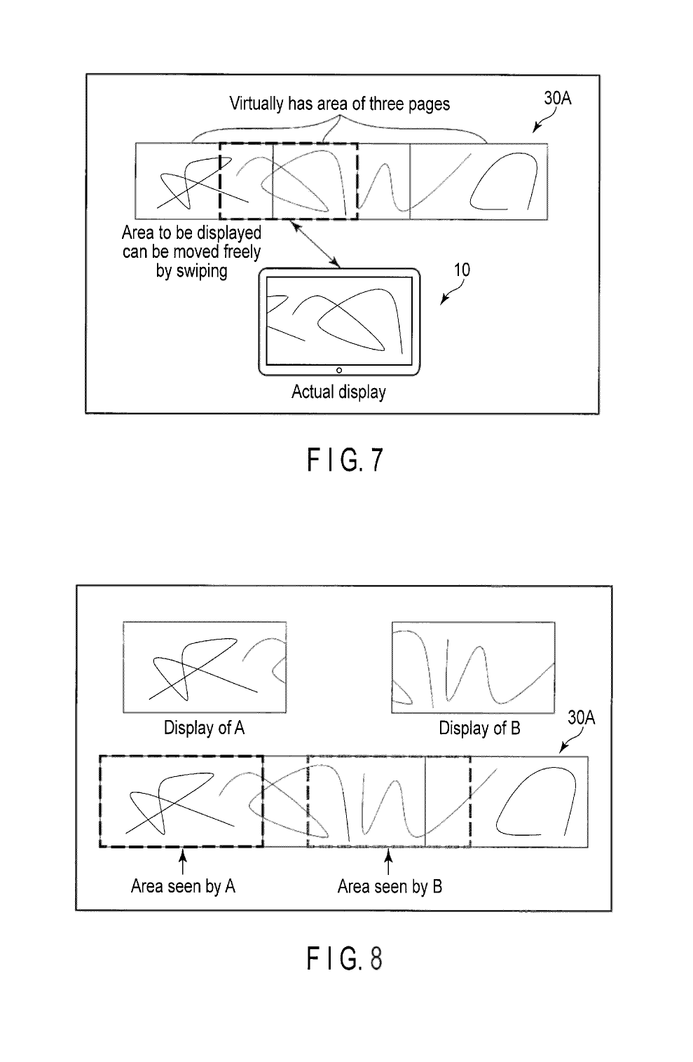

FIG. 7 shows the canvas 30A used in the present embodiment.

As described above, the size of the canvas 30A can be set to exceed a physical screen size (a resolution). Supposing that the physical screen size of the group owner (the organizer) is one page, it is assumed here that the canvas 30A virtually has an area of three pages (which are aligned horizontally). The canvas 30A is used as a share screen (a canvas area) for enabling visual communication between the apparatuses. For example, information input to any portion within the canvas 30A by the group owner (the organizer) is reflected (displayed) in the corresponding portion in the canvas 30A of each participant. Similarly, information input to any portion within the canvas 30A by a certain participant is reflected (displayed) in the corresponding portion in the canvas 30A of the group owner and the corresponding portion in the canvas 30A of each of the other participants.

The user of each electronic apparatus can display an arbitrary area within the canvas 30A on the display by a finger gesture such as a swipe. For example, a display area can be moved within the canvas 30A, and the size of the display area can also be enlarged or reduced. Each user (the participant or the owner) can write text or handwritten data in the current display area. Also, each user can view information written by himself/herself or other users in the current display area.

A default display area displayed in each of the electronic apparatuses when the electronic apparatuses have logged into the handwriting sharing service is determined with reference to, for example, a left end portion of the canvas 30A. The size of a physical screen of each of the electronic apparatuses may be different, and display according to each of the physical screen sizes is performed in the electronic apparatuses.

Next, a preview function included in the handwriting collaboration function of the present embodiment will be described.

As described above, the user of each electronic apparatus can display an arbitrary area within the canvas 30A on the display by a finger gesture such as a swipe. Accordingly, as shown in FIG. 8, a display area seen by a certain user (user A) may be different from a display area seen by another user (user B). Accordingly, there may be requests from the users that they want to grasp which display areas the other users are looking at, and to conform their display area to the display areas seen by the other users. The preview function meets such requests.

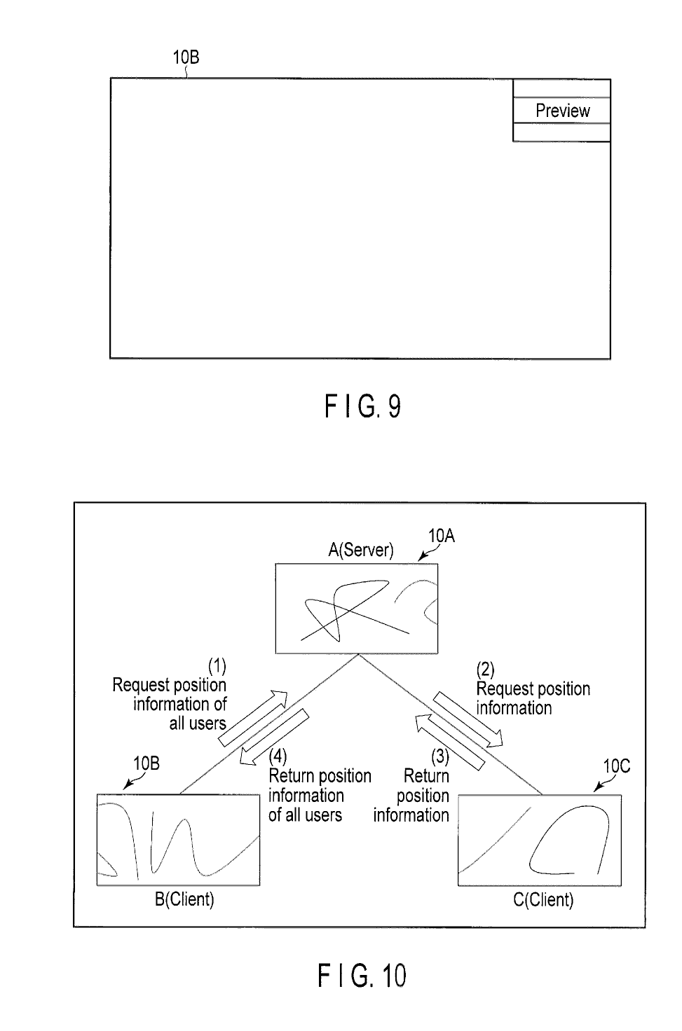

Here, a case where the electronic apparatus 10B performs the preview function, that is, executes preview processing is assumed. Participant 1 can display a menu as shown in FIG. 9 on the touchscreen display 17 of the electronic apparatus 10B. The menu includes a preview button. The preview button is a software button for activating the preview processing for displaying the entire canvas 30A in such a way that the user can identify which part of the canvas 30A (what display area) is currently being displayed in each of the electronic apparatuses. FIG. 10 shows a flow of the preview processing executed by the electronic apparatus of each user.

When the preview button is tapped by the user, the electronic apparatus 10B requests information regarding the current display area of all users to the electronic apparatus 10A of the group owner ((1) in FIG. 10). The information regarding the current display area is, for example, position information at an upper left end portion in the display area within the canvas 30A and position information at a lower right end portion of the same. Further, the information may include a display magnification. The electronic apparatus 10A which received this request requests information regarding the current display area to the electronic apparatus 10C of the other participant ((2) in FIG. 10).

The electronic apparatus 10C which received this request returns information regarding the current display area to the electronic apparatus 10A of the group owner ((3) in FIG. 10). The electronic apparatus 10A returns the information regarding the current display area received from the electronic apparatus 10C, and information regarding the current display area in the electronic apparatus 10A to the electronic apparatus 10B ((4) in FIG. 10).

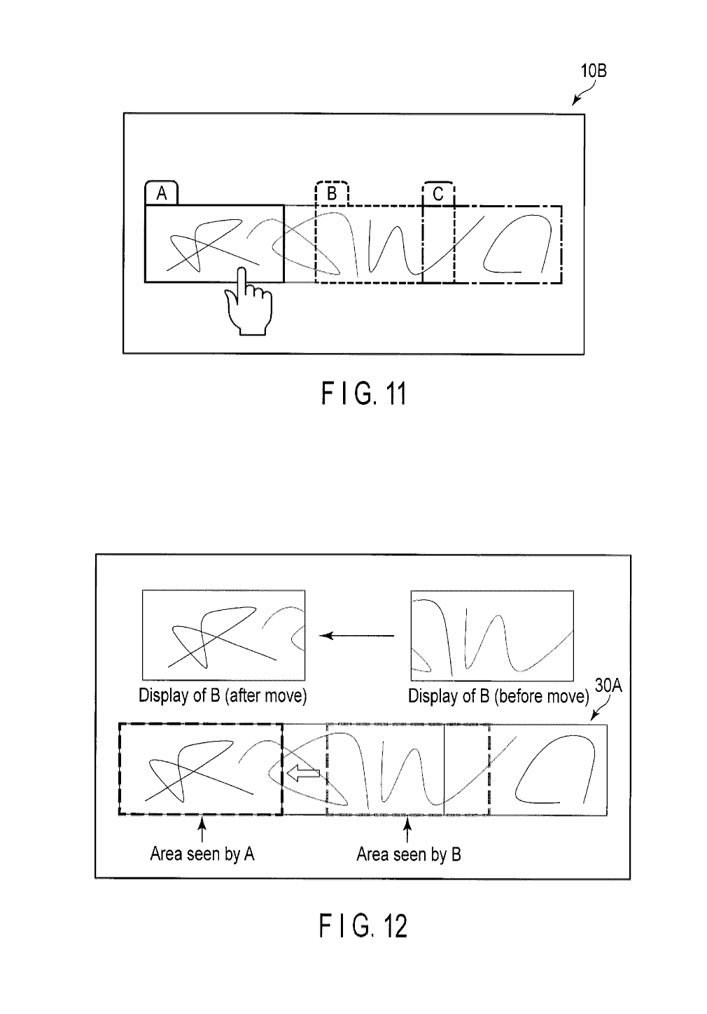

The electronic apparatus 10B specifies the display area which is currently being displayed in each of the other electronic apparatuses based on the information received from the electronic apparatus 10A. Further, as shown in FIG. 11, the electronic apparatus 10B displays a preview image of the canvas 30A which is obtained by, for example, reducing the display of the entire canvas 30A on the display of the electronic apparatus 10B. As shown in FIG. 11, the electronic apparatus 10B displays frames surrounding the display areas seen by the users, respectively. For each of the frames, a tag which serves as an indicator for identifying the user who is seeing the display area surrounded by the frame may be added. The tag may display a user ID or a device ID of the apparatus of the user. Also, the frame may be displayed in a different form (for example, in a different color) for each user. As described above, each user can look down on the entire canvas 30A, and also confirm the current display areas of all users. Note that the display magnification can be changed even when the preview image is being displayed. Accordingly, depending on the magnification, there are cases where the entire canvas 30A is displayed in an enlarged scale to display a preview screen.

Further, when the user (user B) of the electronic apparatus 10B selects, for example, the display area of the electronic apparatus 10A in the preview image of the canvas 30A by a finger gesture such as a touch or a tap, the display area displayed in the electronic apparatus 10B is changed to the display area of the electronic apparatus 10A selected in the preview image, as shown in FIG. 12. As can be seen, each user can easily conform the display area displayed in his/her own apparatus to the display areas seen by the other users (that is, easily move to the display areas seen by the other users).

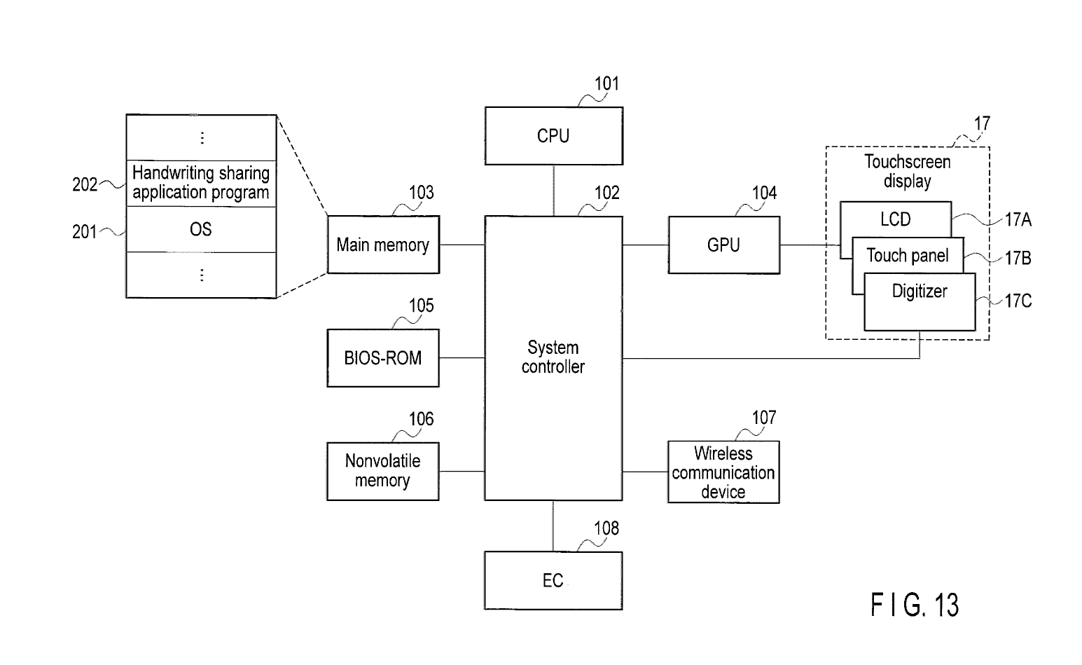

FIG. 13 shows a system configuration of the tablet computer 10.

As shown in FIG. 13, the tablet computer 10 comprises a CPU 101, a system controller 102, a main memory 103, a graphics processing unit (GPU) 104, a BIOS-ROM 105, a nonvolatile memory 106, a wireless communication device 107, an embedded controller (EC) 108, etc.

The CPU 101 is a processor for controlling the operation of various components in the tablet computer 10. The CPU 101 executes various programs loaded into the main memory 103 from the nonvolatile memory 106, which is a storage device. These programs include an operating system (OS) 201, and various application programs. The application programs include a handwriting sharing application program 202. The handwriting sharing application program 202 can execute the aforementioned handwriting collaboration function for sharing the handwritten information among the electronic apparatuses.

The CPU 101 also executes a Basic Input/Output System (BIOS) stored in the BIOS-ROM 105. The BIOS is a program for controlling hardware.

The system controller 102 is a device connecting between a local bus of the CPU 101 and various components. In the system controller 102, a memory controller for access controlling the main memory 103 is also integrated. Also, the system controller 102 comprises the function of executing communication with the graphics processing unit (GPU) 104 via a serial bus, etc., conforming to the PCI EXPRESS standard.

The GPU 104 is a display processor for controlling an LCD 17A to be used as a display monitor of the tablet computer 10. A display signal generated by the CPU 104 is transmitted to the LCD 17A. The LCD 17A displays a screen image based on the display signal. On an upper surface side of the LCD 17A, a touchpanel 17B is arranged. On a lower surface side of the LCD 17A, a digitizer 17C is arranged. The touchpanel 17B is a capacitive pointing device for inputting data on a screen of the LCD 17A. A contact position on the screen touched by a finger and movement and the like of the contact position are detected by the touchpanel 17B. The digitizer 17C is an electromagnetic induction pointing device for inputting data on the screen of the LCD 17A. A contact position on the screen touched by the stylus 100 and movement and the like of the contact position are detected by the digitizer 17C.

The wireless communication device 107 is a device configured to execute wireless communication. The EC 108 is a single-chip microcomputer including an embedded controller for power management. The EC 108 comprises the function of powering the tablet computer 10 on or off in accordance with an operation of a power button by the user.

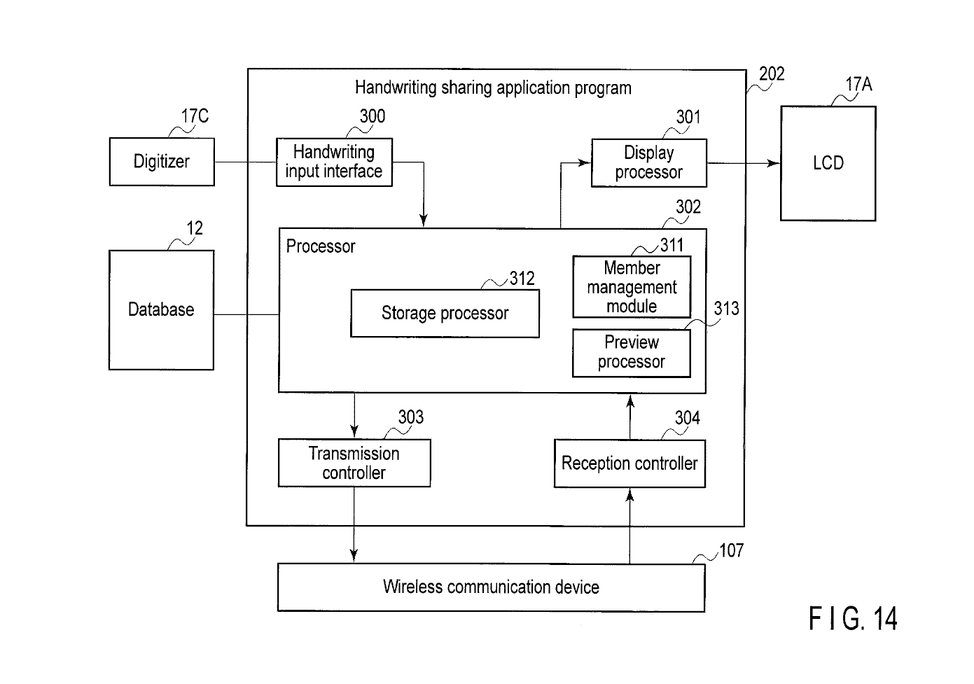

Next, with reference to FIG. 14, a configuration of the handwriting sharing application program 202 will be described.

The handwriting sharing application program 202 includes a handwriting input interface 300, a display processor 301, a processor 302, a transmission controller 303, a reception controller 304, etc., as the function execution modules for sharing the handwritten information.

By using stroke data input with the touchscreen display 17, the handwriting sharing application program 202 creates, displays, and edits handwritten page data. The digitizer 17C of the touchscreen display 17 is configured to detect an occurrence of an event such as a touch, move (slide), and release. A touch is an event indicating that the stylus has touched the screen. A move (slide) is an event indicating that a contact position has moved while the stylus remains in contact with the screen. A release is an event indicating that the external object has been moved away from the screen.

The handwriting input interface 300 is an interface configured to perform handwriting input in cooperation with the digitizer 17C of the touchscreen display 17. The handwriting input interface 300 receives the event of “touch” or “move (slide)” from the digitizer 17C of the touchscreen display 17, and thereby detects a handwriting input operation. The “touch” event includes coordinates of the contact position. Similarly, the “move (slide)” event includes coordinates of a contact position of a moving destination. Accordingly, the handwriting input interface 300 can receive coordinate series (point data) corresponding to a locus of the movement of the contact position from the touchscreen display 17.

The display processor 301 displays a part of or all of the regions in the canvas 30A on the LCD 17A. Also, the display processor 301 displays each stroke input by hand by a handwriting input operation using the stylus 100 on the LCD 17A, on the basis of the coordinate series from the handwriting input interface 300. Further, the display processor 301 displays information written in the canvases 30A of the other electronic apparatuses on the LCD 17A under the control of the processor 302.

The transmission controller 303 uses the wireless communication device 107 under the control of the processor 302 to execute the processing of transmitting the information input to the display area on the LCD 17A to other electronic apparatuses. The reception controller 304 uses the wireless communication device 107 under the control of the processor 302 to execute the processing of receiving the information input to the display areas of the other electronic apparatuses from these electronic apparatuses.

The processor 302 executes the processing of sharing the handwritten information among the electronic apparatuses. The processor 302 includes a member management module 311, a storage processor 312, a preview processor 313, etc.

The member management module 311 manages each member (electronic apparatus) which has logged into the handwriting sharing service. The member management module 311 can determine whether or not to permit an electronic apparatus requesting to log into the handwriting sharing service to log in. The electronic apparatus which has received permission from the member management module 311 is allowed to log into the handwriting sharing service, and is thereby connected to each of the other electronic apparatuses already logged into the handwriting sharing service. The function of the member management module 311 may be executed in only the electronic apparatus which functions as the handwriting collaboration server system (i.e., the electronic apparatus of the group owner).

The storage processor 312 executes the processing of storing the data received from other electronic apparatuses in the database 12. Each data may be stored in the database 12 in a state where it is associated with the display area. With respect to the handwritten data, each point data is stored in the database 12 together with a timestamp.

The preview processor 313 executes the aforementioned preview processing. When the preview button displayed on the LCD 17A is operated by the user, the preview processor 313 displays a preview image of the entire canvas 30A on the LCD 17A in such a way that the user can identify which part of the canvas 30A (what display area) is currently being displayed in each of the electronic apparatuses. Further, when any of display areas of the preview image is selected, the display area of this apparatus is switched to the selected display area.

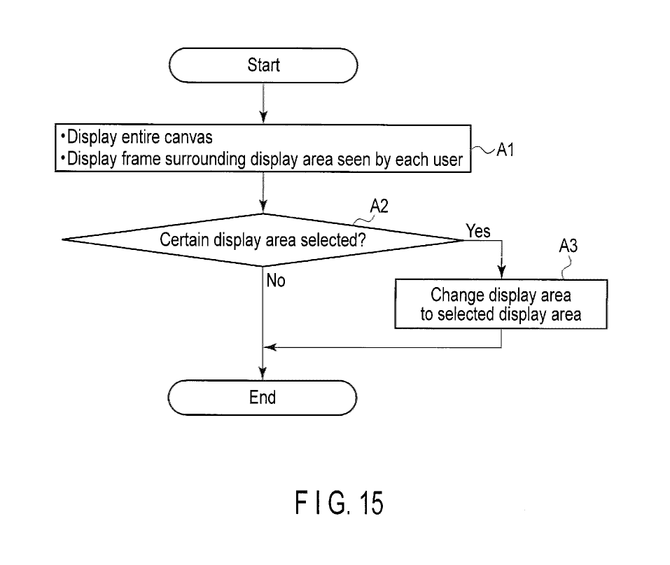

FIG. 15 is an exemplary flowchart showing a procedure of the preview processing.

When the preview button is operated by the user, the processor 302 generates a preview image of the canvas 30A by, for example, displaying the entire canvas 30A in a reduced scale (block A1). As described above, since the display magnification can be changed even when the preview image is being displayed, depending on the magnification, the entire canvas 30A may be displayed in an enlarged scale to display a preview screen.

The processor 302 specifies the display areas which are currently being displayed in the other electronic apparatuses by making a query to the electronic apparatus of the group owner about the respective display areas currently being displayed. Then, the processor 302 displays the preview image on the LCD 17A in such a way that the user can identify which part of the canvas 30A (what display area) is currently being displayed in each of the electronic apparatuses. For example, the processor 302 may display frames surrounding the display areas seen by the users, respectively, in the preview image. Also, the processor 302 can display information (for example, a tag, etc., described with reference to FIG. 11) by which a user who is seeing each of the display areas can be identified in the preview image.

The processor 302 determines whether a display area (an area surrounded by a frame) in the preview image is selected by the user (block A2). When a display area in the preview image is selected by the user (YES in block A2), the processor 302 terminates the processing of displaying the preview image, and instead displays the selected display area in a normal size on the LCD 17A (block A3).

As described above, in the present embodiment, each user can look down on the entire canvas 30A, and also confirm the current display areas of all users. Also, each user can easily conform the display area displayed in his/her own apparatus to the display areas seen by the other users (that is, easily move to the display areas seen by the other users) where necessary.

Note that the function of the handwriting collaboration server system (electronic apparatus 10A) of the present embodiment can be realized by one or more processors.

Also, since the function of the handwriting collaboration server system (electronic apparatus 10A) of the present embodiment can be realized by a computer program, it is possible to easily realize an advantage similar to that of the present embodiment by simply installing a computer program on a computer by way of a computer-readable storage medium having stored thereon the computer program, and executing this computer program.

Each of various functions described in the present embodiment may be realized by a processing circuit. Examples of the processing circuit include a programmed processor such as a central processing unit (CPU). The processor executes each of the described functions by executing a program stored in a memory. The processor may be a microprocessor including circuitry. Examples of the processing circuit include a digital signal processor (DSP), application specific integrated circuits (ASIC), a microcontroller, a controller, and other electric circuit components.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising circuitry configured to display, on a display, a first region of an electronic document comprising a first stroke input by handwriting on the electronic apparatus and a second stroke input by handwriting on another apparatus, wherein the first region is being displayed on the display and is at least a part of the electronic document,
wherein a second region is visually distinguishable from other region of the electronic document when a first operation is performed, the second region is being displayed on the another apparatus and is at least a part of the electronic document.

2. The apparatus of claim 1, wherein the circuitry is configured to, when a second operation to specify the second region is performed in a state where the second region is visually distinguishable from the other region of the electronic document:
switch a display target of the apparatus from the first region to the second region; and
display the second region on the display.

3. The apparatus of claim 1, wherein when the first operation is performed:
the first region and the second region are visually distinguishable from other region of the electronic document; and
a region comprising at least the first region and the second region is displayed on the display.

4. The apparatus of claim 1, wherein the circuitry is configured to display a stroke being input or a most recently input stroke distinguishable from other strokes, when the circuitry displays the first region on the display.

5. The apparatus of claim 1, wherein the circuitry is configured to display a stroke that is input within a first period distinguishable from other strokes that are not input within the first period, when the circuitry displays the first region on the display.

6. The apparatus of claim 1, wherein a region of whole of the electronic document comprises a number of pixels whereby a resolution is higher than a resolution of the display.

7. A processing method of an electronic apparatus, the method comprising displaying, on a display, a first region of an electronic document comprising a first stroke input by handwriting on the electronic apparatus and a second stroke input by handwriting on another apparatus, wherein the first region is being displayed on the display and is at least a part of the electronic document, wherein a second region is visually distinguishable from other region of the electronic document when a first operation is performed, the second region is being a displayed on the another apparatus and is at least a part of the electronic document.

8. The method of claim 7, further comprising switching a display target of the apparatus from the first region to the second region, and displaying the second region on the display, when a second operation to specify the second region is performed in a state where the second region is visually distinguishable from the other region of the electronic document.

9. The method of claim 7, wherein when the first operation is performed:
the first region and the second region are visually distinguishable from other region of the electronic document; and
a region comprising at least the first region and the second region is displayed on the display.

10. The method of claim 7, wherein the displaying the first region on the display comprises displaying a stroke being input or a most recently input stroke distinguishable from other strokes.

11. The method of claim 7, wherein the displaying the first region on the display comprises displaying a stroke that is input within a first period distinguishable from other strokes that are not input within the first period.

12. The method of claim 7, wherein a region of whole of the electronic document comprises a number of pixels whereby a resolution is higher than a resolution of the display.

13. A computer-readable, non-transitory storage medium having stored thereon a computer program which is executable by a computer, the computer program controlling the computer to function as circuitry configured to display, on a display, a first region of an electronic document comprising a first stroke input by handwriting on the computer and a second stroke input by handwriting on another apparatus, wherein the first region is being displayed on the display and is at least a part of the electronic document,
wherein a second region is visually distinguishable from other region of the electronic document when a first operation is performed, the second region is being displayed on the another computer and is at least a part of the electronic document.

14. The medium of claim 13, wherein the circuitry is configured to, when a second operation to specify the second region is performed in a state where the second region is visually distinguishable from the other region of the electronic document:
switch a display target of the computer from the first region to the second region; and
display the second region on the display.

15. The medium of claim 13, wherein when the first operation is performed:
the first region and the second region are visually distinguishable from other region of the electronic document; and
a region comprising at least the first region and the second region is displayed on the display.

16. The medium of claim 13, wherein the circuitry is configured to display a stroke being input or a most recently input stroke distinguishable from other strokes, when the circuitry displays the first region on the display.

17. The medium of claim 13, wherein the circuitry is configured to display a stroke that is input within a first period distinguishable from other strokes that are not input within the first period, when the circuitry displays the first region on the display.
